(19) United States
(12) Patent Application Publication
(10) Pub. No.: US 2008/0244651 A1
(43) Pub. Date: Oct. 2, 2008

(54) BROADCAST RECEIVING APPARATUS AND BROADCAST RECEPTION METHOD

(75) Inventor: Hiroyuki Komori, Fukaya-shi (JP)

Correspondence Address: BLAKELY SOKOLOFF TAYLOR & ZAFMAN LLP, 1279 OAKMEAD PARKWAY, SUNNYVALE, CA, 94085-4040, US

(73) Assignee: KABUSHIKI KAISHA TOSHIBA, Tokyo (JP)

(21) Appl. No.: 12/048,039

(22) Filed: Mar. 13, 2008

(30) Foreign Application Priority Data
Mar. 29, 2007 (JP) 2007-086129

(51) Int. Cl. H04N 5/445

(52) U.S. Cl. 725/39

(57) ABSTRACT

According to one embodiment, there is provided a broadcast receiving apparatus includes a tuner which selects one from a plurality of channels, demodulates a selected broadcast signal, and outputs a demodulation signal, an extracting unit extracting an electronic program information from the demodulation signal output, a superimposing unit which produces a video signal based on given channel history information and program title information corresponding to the channel history information, and superimposes the video signal onto a video signal produced based on the demodulation signal, and a control unit which stores the channel history information selected by the tuner, extracts the program title information corresponding to the channel history information from the electronic program information of the extracting unit, and supplies the program title information to the superimposing unit together with the channel history information.

### CROSS-REFERENCE TO RELATED APPLICATIONS

This application is based upon and claims the benefit of priority from Japanese Patent Application No. 2007-086129, filed Mar. 29, 2007, the entire contents of which are incorporated herein by reference.

### BACKGROUND

1. Field

One embodiment of the invention relates to a broadcast receiving apparatus and a broadcast reception methods for displaying on a screen a history of channels selected and program titles corresponding to those channels.

2. Description of the Related Art

As is generally known, ground wave digital broadcasting has become widespread in recent years. This makes it possible to easily view, together with sound, images higher in quality than those in conventional analog digital broadcasting. However, ground wave digital broadcasting must decode MPED (Moving Picture Expert Group) packets obtained from ground wave digital broadcast signals. It takes several seconds to reproduce an image after a channel change. Specifically, it takes a few seconds for a screen to actually change in response to a channel switching operation. During such channel switching, the screen shows nothing, which means that screen response is inferior to that in switching channel on a conventional analog tuner. This does not allow a user to search for a program he or she likes by quickly switching channel as in conventional analog tuners.

In view of the drawbacks discussed above, Patent Document 1 (Jpn. Pat. Appln. KOKAI Publication No. 2005-45508) uses a plurality of tuners such that while one tuner selects a channel, another tuner retains the channel before the channel switching operation takes place. Accordingly, eliminating the moment when the screen shows nothing by virtue of the reproduction makes the inferior response of the screen unnoticeable.

However, the known technology disclosed in the patent document 1 needs a plurality of tuners, which inevitably leads to a cost increase. Also, this technology does not shorten the time taken to decode packets. In addition, this does not allow a user to search for a program he or she likes after actually viewing images on each channel while quickly switching a channel as with an analog tuner.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a view illustrating an example of a channel history display shown by a broadcast receiving apparatus according to one embodiment of the invention;

FIG. 2 is a view illustrating another example of the channel history display shown by the broadcast receiving apparatus according to the present embodiment of the invention;

FIG. 3 is a block diagram showing an example of the configuration of the broadcast receiving apparatus according to the present embodiment of the invention;

FIG. 4 a flowchart illustrating an example of a channel history display process performed by the broadcast receiving apparatus according to the present embodiment of the invention;

FIG. 5 a flowchart illustrating another example of the channel history display process performed by the broadcast receiving apparatus according to the present embodiment of the invention;

FIG. 6 a flowchart illustrating another example of the channel history display process performed by the broadcast receiving apparatus according to the present embodiment of the invention;

FIG. 7 is a view illustrating an example of a channel history setting display shown by the broadcast receiving apparatus according to the present embodiment of the invention;

FIG. 8 is a view illustrating an example of a channel display (favorite channel display) shown by the broadcast receiving apparatus according to the present embodiment of the invention;

FIG. 9 is a view illustrating a channel history bundle display process performed by the broadcast receiving apparatus according to the present embodiment of the invention;

FIG. 10 is a view illustrating an operation for channel selection in which the present embodiment of the invention is not applied; and

FIG. 11 is a view illustrating an example of an electronic display showing a list of programs, in which the present embodiment of the invention is not applied.

### DETAILED DESCRIPTION

Various embodiments according to the invention will be described hereinafter with reference to the accompanying drawings. In general, according to one embodiment of the invention, a broadcast receiving apparatus comprising: a tuner which selects one from a plurality of channels, demodulates a selected broadcast signal, and outputs a demodulation signal; an extracting unit which extracts an electronic program information from the demodulation signal output from the tuner; a superimposing unit which produces a video signal based on given channel history information and program title information corresponding to the channel history information, and superimposes the video signal onto a video signal produced based on the demodulation signal; and a control unit which stores the channel history information selected by the tuner, extracts the program title information corresponding to the channel history information from the electronic program information of the extracting unit, and supplies the program title information to the superimposing unit together with the channel history information.

It is therefore an object of the invention to provide a broadcast receiving apparatus and a broadcast reception method for displaying on screen a history of channels selected and program titles corresponding to the channels, thereby making it easy for a user to select a channel.

On embodiment to achieve the above object is a broadcast receiving apparatus comprising:

a tuner (12) which selects one from a plurality of channels, demodulates a selected broadcast signal, and outputs a demodulation signal;

an extracting unit (36) which extracts an electronic program information from the demodulation signal output from the tuner;

a superimposing unit (34) which produces a video signal based on given channel history information and program title information corresponding to the channel history information, and superimposes the video signal onto a video signal produced based on the demodulation signal; and

a control unit (30) which stores the channel history information selected by the tuner, extracts the program title information corresponding to the channel history information from the electronic program information of the extracting unit, and supplies the program title information to the superimposing unit together with the channel history information.

In this configuration, every time channel switching takes place, a history of channels and corresponding program titles are displayed on screen. Accordingly, even where it takes time to mount the display due to decoding of packets as in ground wave digital broadcasting, a user can remember channels and programs he or she has checked by viewing them.

Referring to the accompanying drawings, an embodiment of the invention will now be described in detail.

<Example of Broadcast Receiving Apparatus according to One Embodiment of the Invention>

First, a detailed description of an example of a broadcast receiving apparatus according to the present embodiment of the invention will be given with reference to the drawings.

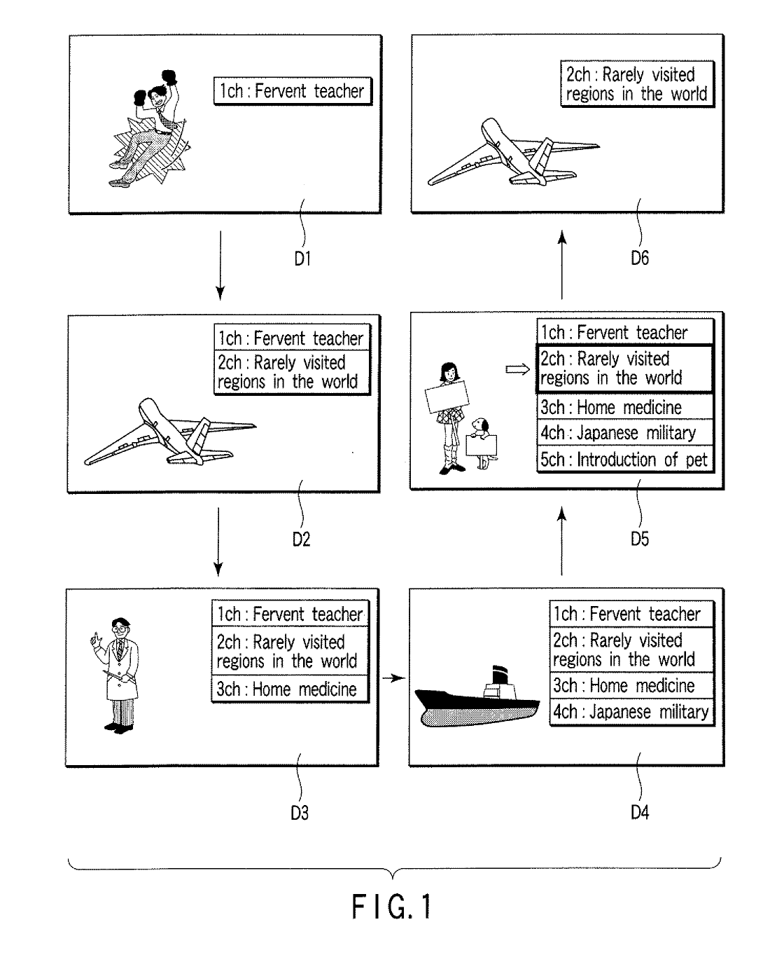

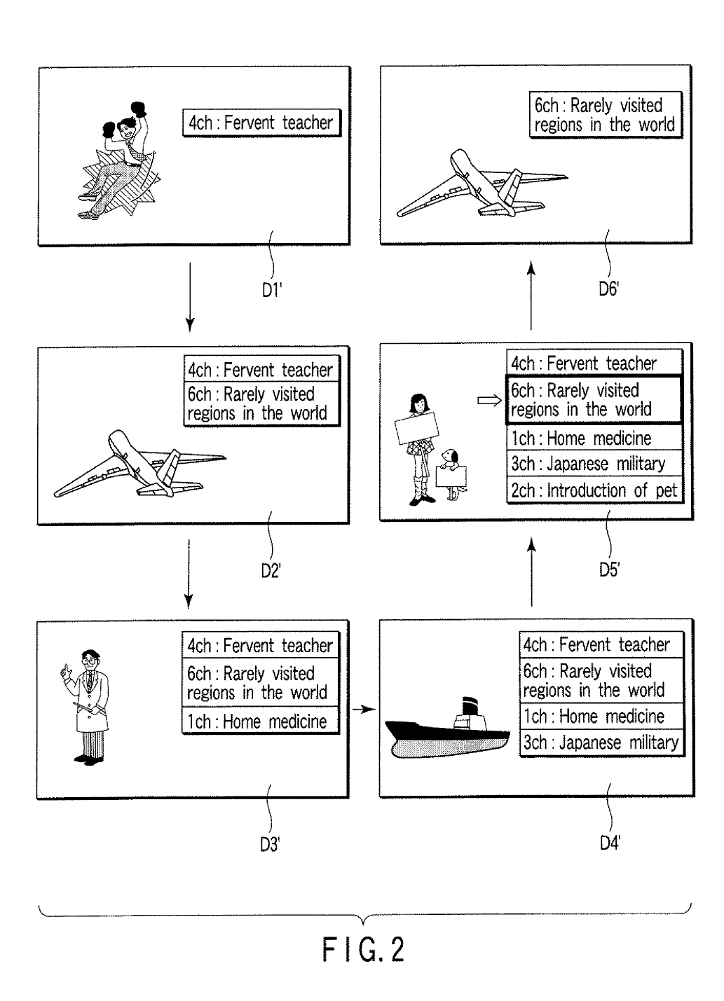

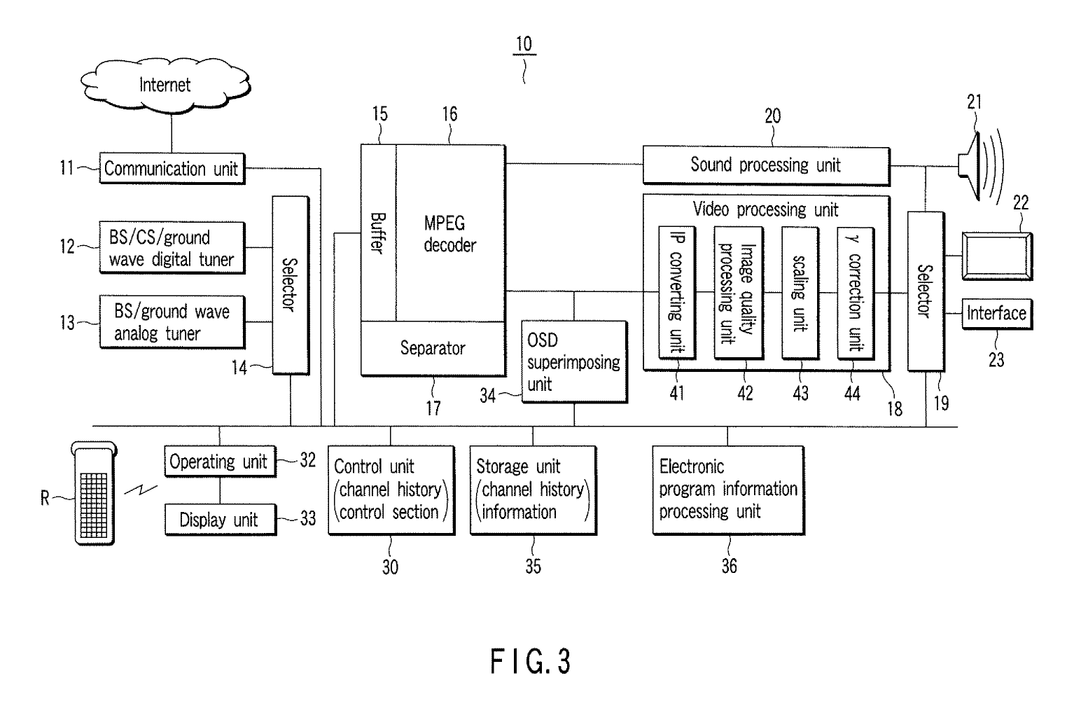

FIGS. 1 and 2 are views illustrating examples of channel history displays shown by the broadcast receiving apparatus, and FIG. 3 is a block diagram showing an example of the configuration of the broadcast receiving apparatus.

As shown in FIG. 1, every time channel switching takes place with a channel switch key or suchlike, the broadcast receiving apparatus according to the present embodiment adds and stores channel history information and lists past channel information on each of displays D1 to D5 only for a given time. Here, for example, if one item of channel history (e.g., 2ch) on the display D5 is specified with a cursor by operating the keys of a remote controller or such like, the television switches to the channel (2ch).

Specifically, although it takes time to switch a channel, channel information is listed on a screen together with their program titles each time channel switching takes place. This enables a user to remember a history of programs and their channels he or she has checked and allows easy search for a program he or she likes from the history.

FIG. 1 shows an example where a channel switching operation is carried out using a channel forward or back key. FIG. 2 shows an example where a history of program titles and their channels can also be displayed by a channel switching operation using channel number keys.

(Configuration of Broadcast Receiving Apparatus)

Referring to the accompanying drawings, a detailed description of an example of the configuration of the broadcast receiving apparatus, such as a digital television, according to the one embodiment of the present invention is given below. FIG. 3 is a block diagram showing an example of the configuration of the broadcast receiving apparatus according to the present invention. The present embodiment can be applied not only in digital televisions but also in recording reproducers, such as hard disk recorders, which have the function of receiving ground wave digital broadcasting.

A broadcast receiving apparatus 10 is an example of a television apparatus, as shown in FIG. 3, and a control unit 30 is connected to each unit via a data bus in order to control the entire operation. The broadcast receiving apparatus 10 includes: as its main component, an MPEG decoder 16 composing the reproducer, and the control unit 30 that controls the operation of the apparatus main body. The broadcast receiving apparatus 10 has an input-side selector 14 and an output-side selector 19. Connected to the input-side selector 14 are: a communication unit 11 having functions of mailer, LAN or the like; BS/CS/ground wave digital tuner 12; and BS/ground wave analog tuner 13.

The broadcast receiving apparatus 10 further includes: a buffer 15, a separator 17, the MPED decoder 16, and an OS (On Screen Display) superimposing unit 34. The buffer 15 temporarily stores a demodulation signal from the BS/ground wave digital tuner 12. The separator 17 separates packets (i.e., stored demodulation signals) into groups according to types. The MPED decoder 16 subjects a video sound signal packet supplied by the separator 17 to an MPEG decoding process, thereby outputting video and sound signals. The OSD superimposing unit 34 superimposes operation information, etc., on the video signal. The broadcast receiving apparatus 10 further includes: a sound processing unit 20, a video processing unit 18, the selector 19, a speaker 21, a display unit 22, and an interface 23. The sound processing unit 20 subjects the sound signal from the MPED decoder 16 to an amplifying process, etc. The video processing unit 18 receives the video signal from the MPEG decoder 16 and OCD superimposing unit 34, and subjects the video signal to a desired video-processing. The selector 19 selects a destination to which the sound signal and video signal are output. The speaker 21 outputs sound according to the sound signal from the sound processing unit 20. The display unit 22 displays a picture according to the video signal produced as a result of the connection to the selector 19 on a liquid crystal display screen or the like. The interface 23 communicates with external devices.

To be specific, the video processing unit 18 has: an IP converting unit 41 which converts an interlace signal into a progressive signal; an image quality processing unit 42 which performs a coring process or an enhancing process; a scaling unit 43 which performs a scaling process; and a γ correction unit 44 which subjects the video signals to a γ correction.

Further, the broadcast receiving apparatus 10 further includes: a storage unit 35 which records, as necessity requires, video information, etc., transmitted from the BS/ground wave analog tuner 13; and an electronic program information processing unit 36 which captures electronic program information from broadcast signals and so on and displays the information on a screen or the like. The storage unit 35 and electronic program information processing unit 36 are connected to the control unit 30 via the data bus. In addition, the broadcast receiving apparatus 10 includes: an operating unit 32 that is connected to the control unit 30 via the data bus to respond to operations input by a user or through a remote controller R; and a display unit 33 that displays operation signals. The remote controller R has a function substantially identical to that of the operating unit 32 of the main body of the broadcast receiving apparatus 10, and allows various settings such as operating a tuner.

In the broadcast receiving apparatus 10 having such a configuration, a broadcast signal is input from a reception antenna to each tuner 12, 13, where a channel is selected. Modulation signals in a packet form, acquired by demodulation after the selection, are separated into groups according to packet type by the separator 17. Each sound video packet is decoded into video and sound signals by the MPEG decoder 16, etc., and the video and sound signals are supplied to the sound processing unit 20 and the video processing unit 18. In the video processing unit 18, the supplied video signal is subjected to conversion from an interlace to a progressive signal by the IP converting unit 41, then, subjected to a coring process and enhancement process by the image quality processing unit 42, and then, a scaling process by the scaling unit 43, and γ correction by the γ correction unit 44. Thereafter, this video signal is supplied to the selector 19.

The selector 19 supplies the video signal thus processed to, for example, the display unit 22 according to a control signal transmitted by the control unit 30. Consequently, a picture from the video signal is displayed on the display unit 22. In addition, sound corresponding to the sound signal supplied from the sound processing unit 20 is output from the speaker 21.

In the OS superimposing unit 34, channel history information, program title information, etc., which are described below, are superimposed on the video signal corresponding to a broadcast signal, then passed through the video processing unit 18, and an image corresponding to this is shown on the display unit 22.

<Channel History Information Display Process of Broadcast Receiving Apparatus According to the Present Embodiment of the Invention>

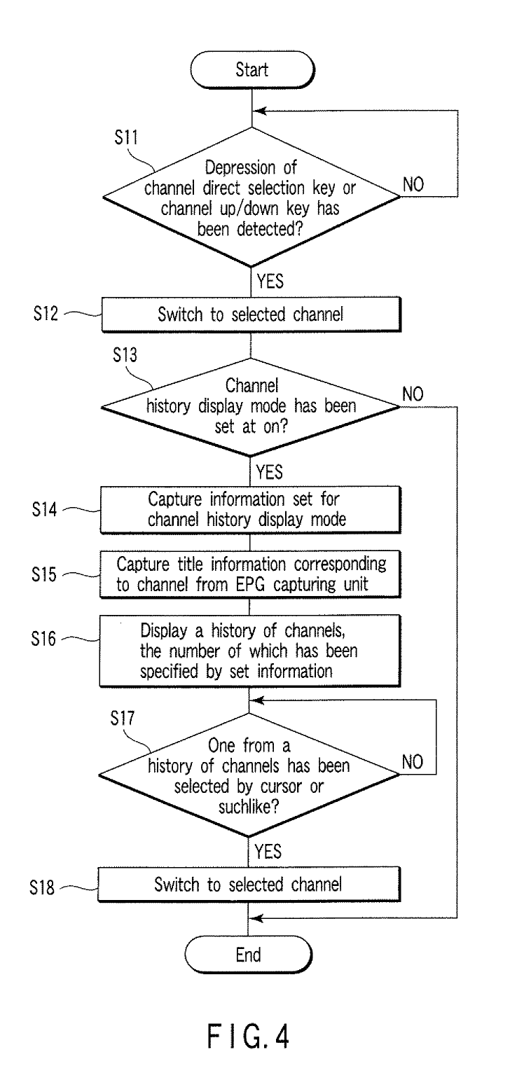

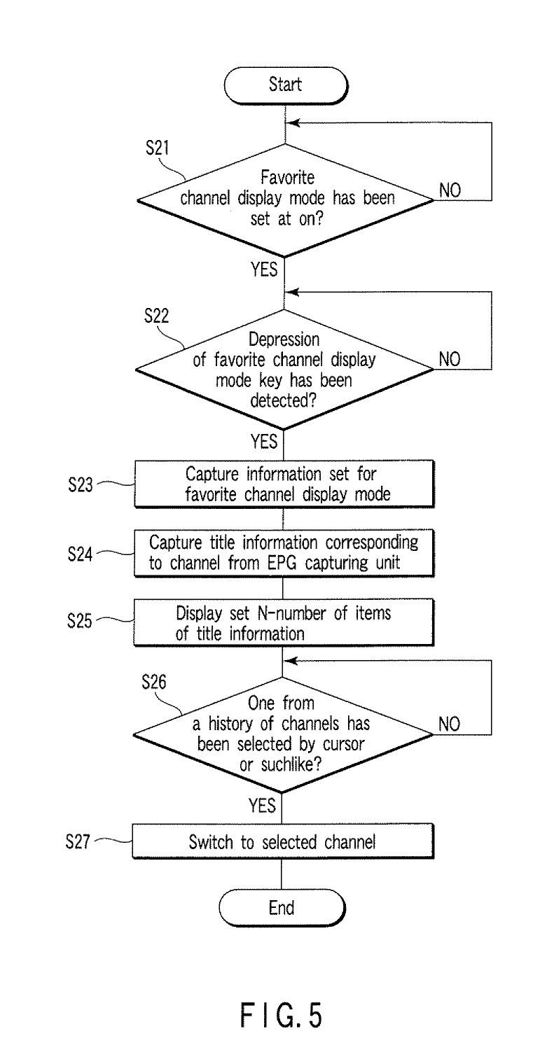

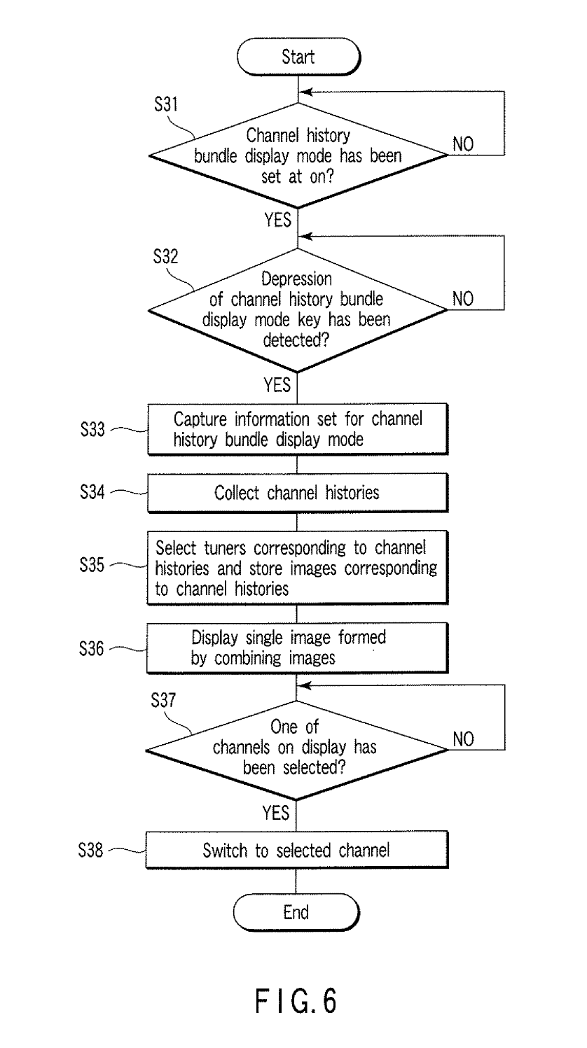

Next, an example of the channel history information display process performed by the broadcast receiving apparatus 10 having the foregoing configuration will be described in detail with reference to flowcharts in FIGS. 4 to 6. FIG. 4 is a flowchart illustrating an example of the channel history display process mentioned above. FIG. 5 is a flowchart illustrating an example of a channel display process in a favorite channel display mode. FIG. 6 is a flowchart illustrating an example of the channel history display process in which a history of images is displayed simultaneously.

Incidentally, each step of the flowcharts in FIGS. 4 to 6 can be replaced with and therefore defined by a circuit block.

(Channel Selection in which the Present Embodiment of the Invention is Not Applied)

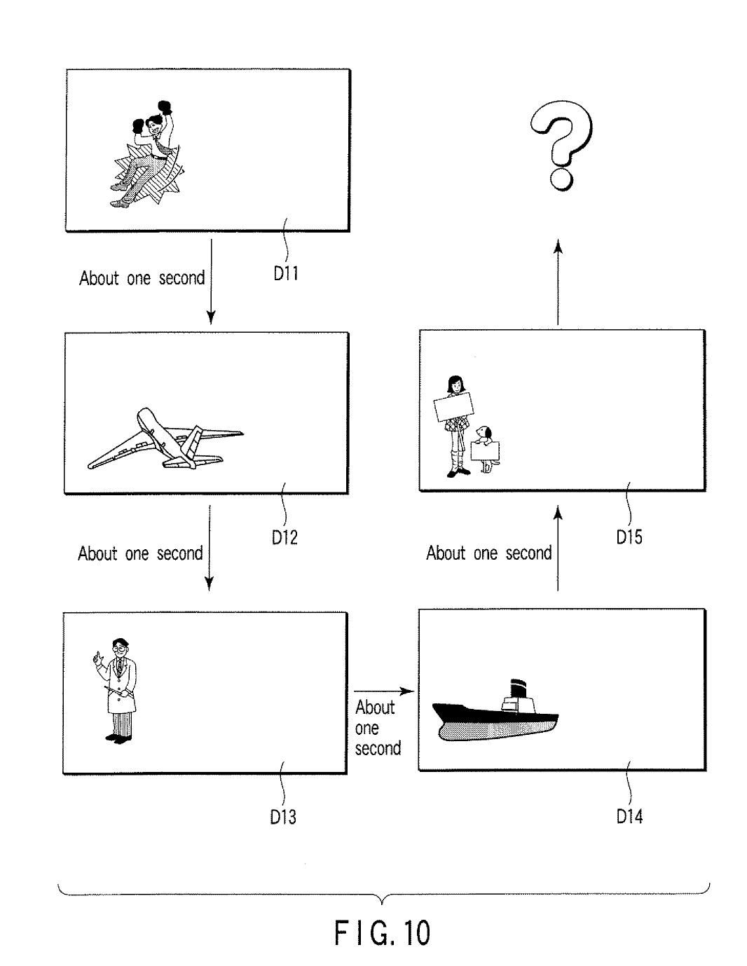

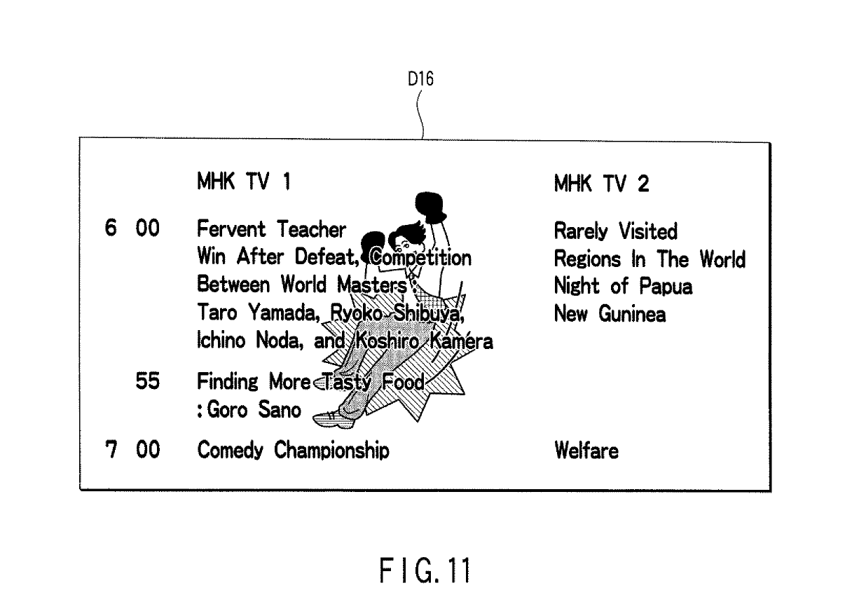

First, channel selection in which the present embodiment of the invention is not applied will be described below with reference to FIGS. 10 and 11. FIG. 10 is a view illustrating an actual operation for channel selection in which the present embodiment is not applied. FIG. 11 is a view illustrating an example of an electronic display showing a list of programs, in which the present embodiment is not applied.

Specifically, in a typical television designed for ground wave broadcasting, the screen is switched from display D11 to D15 one after another, as shown in FIG. 10, by a channel switching operation. However, the image is not instantaneously switched as in an analog tuner but is switched after one to several seconds. This is because, in ground wave digital broadcasting, images are displayed after a fixed quantity of packet signals have been decoded within a digital tuner. Therefore, unless the processing speed improves greatly, it is impossible to check programs while instantaneously switching display as in conventional analog tuners. Accordingly, if a user who has switched channels to display D14 wants to view again, say, an airplane shown in display D12, he or she may not be able to remember the channel for the display D12 and may feel that such channel selection is inconvenient.

On the other hand, in program selection using EPG (Electronic Program) information, only some programs from a list of programs are displayed in detail and the others not in detail, as shown in FIG. 11. This makes it difficult to correctly judge from the list what program is on each channel because a user cannot view actual images from the channels.

(Channel History Display Process: FIG. 4)

Referring to a flowchart in FIG. 4, the channel history display process performed by the broadcast receiving apparatus according to the present invention will now be described. As shown in FIGS. 1 and 2, the channel history display process is the process of displaying on a screen a history of channels selected by a user and program titles corresponding to the channels Accordingly, even in broadcasting such as ground wave digital broadcasting, which takes time to display images on a screen, a user can easily select a channel he or she likes by checking the images on several channels and then referring to the channels and corresponding program titles displayed on the screen.

The channel history display process by the broadcast receiving apparatus according to the present embodiment proceeds as shown in a flowchart in FIG. 4. If it detects a depression of the channel direct selection key or channel up-down key of the remote controller R or main body operating unit 32 (step S11), the channel history control section of the control unit 30 switches the BS/CS/ground wave digital tuner 12 to the selected channel (S12). At this time, the channel history control section determines whether a channel history display mode has been set or not (step S13).

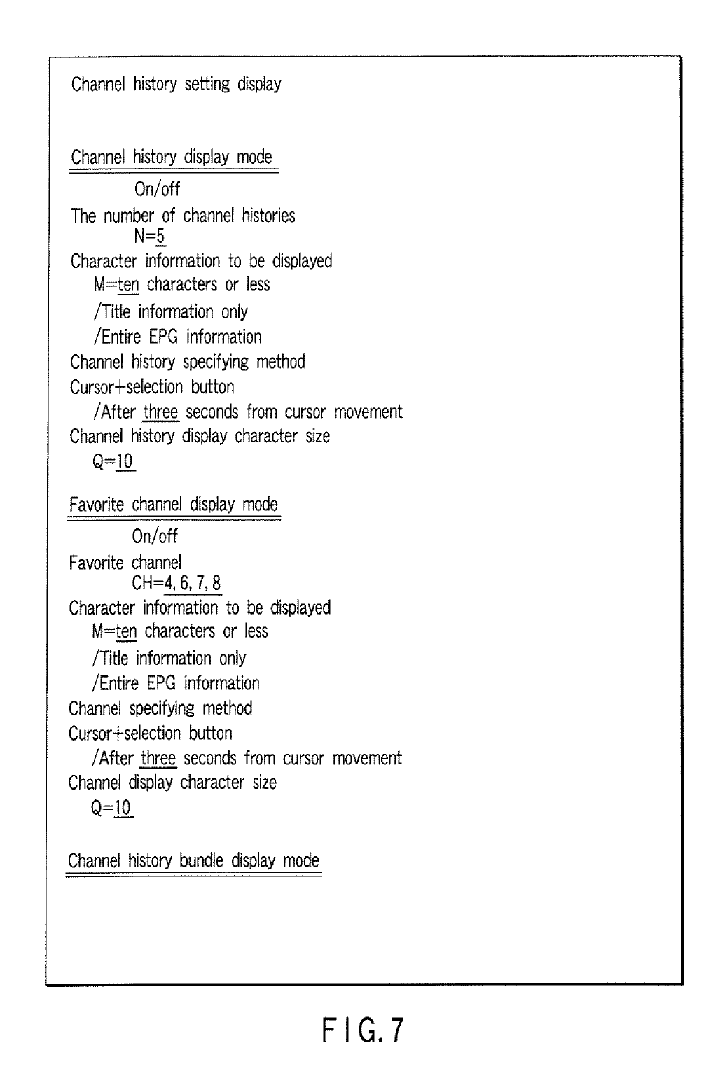

In this case, the channel history control section shows a screen as in FIG. 7, which is used to enter settings through the operation of the remote controller R or operating unit 32. FIG. 7 is a view illustrating an example of a channel history setting display.

Specifically, as shown in FIG. 7, a user can set a “channel history display mode,” “favorite channel display mode,” or “channel history bundle display mode.” First, the “channel history display mode” will be described.

As shown in FIG. 7, the “channel history display mode” can be set on or off and the number of channels to be displayed can be set like “N=5.”

In addition, character information for EPG information to be displayed can be set by entering the number of characters, such as “M=ten characters or less,” with the remote controller R or suchlike or by selecting “title information only,” or “entire EPG information.”

As the “channel history specifying method” for selecting one from a history of channels displayed on the screen, specifying with “cursor+selection button” or entering the number of seconds as in “after three seconds from cursor movement” with the remote controller R or suchlike can be selected.

Further, a “channel history display character size” can be set by entering a character size such as “Q=10” with the remote controller R or suchlike.

The channel history control section of the control unit 30 ends the process if the “channel history display mode” is set at off on a setting display, as shown in FIG. 4, or captures items of information set for the “channel history display mode” if it has been set at on (step S14). Then, the channel history control section records in the storage section 35 the items of channel history information selected with the remote controller or suchlike by a user. Subsequently, according to these items of information specified, the electronic program information processing unit 36 extracts the items of title information corresponding to the set N-number of channels from items of electronic program information captured from the broadcast signals, etc., of ground wave digital broadcasting (step S15).

Next, in order to display the history of the N-number of channels, the channel history control section causes the OSD superposing unit 34 to create image information that includes both each channel history and title information corresponding to the channel. Then, the unit 34 superimposes this image information onto video signals transmitted by the MPEG decoder unit 16, thereby showing the displays D1 to D5, as shown in FIG. 1 or 2, on the display unit 22 (step S16).

If one from the history of channels is selected by a cursor or suchlike with reference to the items of channel history information and title information corresponding to the channels (step 317), the channel history control section switches the BS/CS/ground wave tuner 12 to the selected channel (Step S18). Thus, even in broadcasting such as ground wave digital broadcasting, which takes time to display on a screen, a user can easily select a channel he or she likes by checking actual pictures on several channels and then referring both to these channels and to corresponding program titles listed on the screen.

(Favorite Channel Program Title and Display Process: FIG. 5)

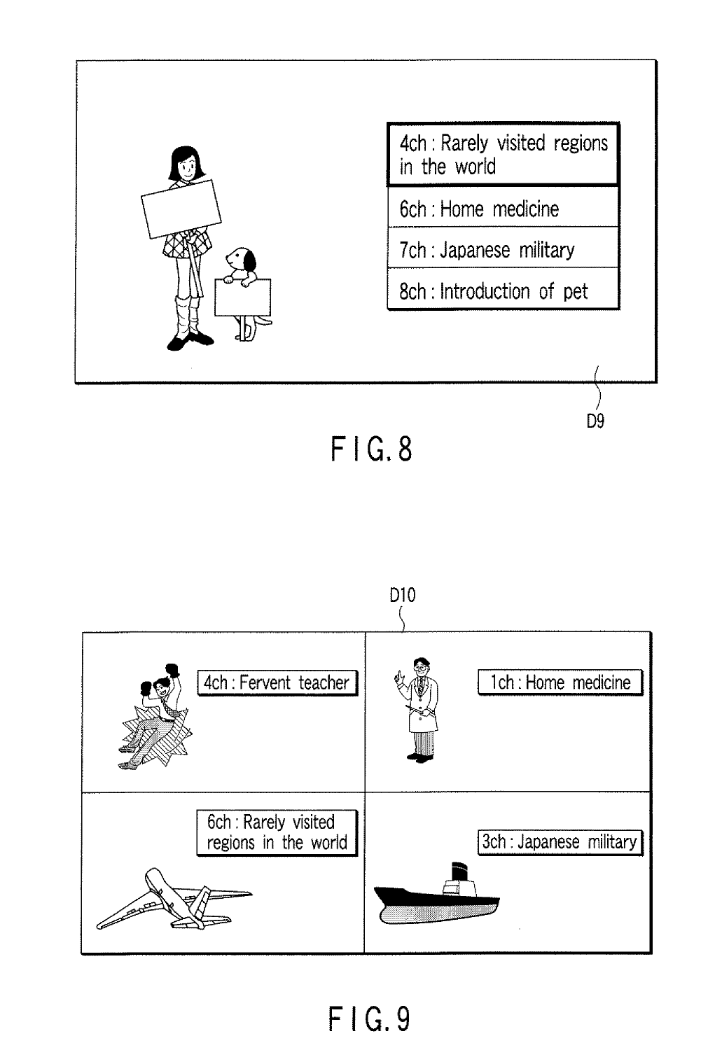

The favorite channel program title display process performed by the broadcast receiving apparatus according to the present embodiment will now be described with reference to a flowchart in FIG. 5. The favorite channel program title display process is the process that displays sets of items of channel information and corresponding program titles onto a screen, as shown in FIG. 8. These items of channel information correspond to channels arbitrarily selected on the setting display (see FIG. 7) by a user. This enables the user to remember the titles of programs he or she always watches, even in as the case of ground wave digital broadcasting which takes time to display on a screen. Accordingly, the user can select the channel he or she likes from the list of program titles.

In this case, the channels arbitrarily selected may be, for example, all channels receivable by ground wave broadcasting, and the titles of the programs on all the channels may be displayed on the screen.

The channel history display process by the broadcast receiving apparatus according to the present embodiment proceeds as shown in a flowchart in FIG. 5. First, the channel history control section of the control unit 30 determines whether a favorite display mode has been set or not on the setting display, as shown in FIG. 7 (step S21).

In “favorite channel setting,” a channel setting mode can be set on or off, as shown in FIG. 7. A user can arbitrarily set favorite channels corresponding to program titles which he or she wants to display, by entering numerical values, such as “CH=4, 6, 7, and 8,” with the remote controller R or such like. In this case, all channels receivable by ground wave broadcasting may be set.

Character information for displaying EPG information can be set by entering the number of characters, such as “M=10 characters or less,” with the remote controller R or by selecting the display entry “title information only” or “entire EPG information” (not shown).

A “channel specifying method” for one from a history of channels displayed on the screen may be specified with “cursor+selection button” or entering the number of seconds as in “after three seconds from cursor movement” with the remote controller R or suchlike.

Further, a “channel display character size” can be set by entering a character size such as “Q=10” with the remote controller R or suchlike.

The channel history control section of the control unit 30 ends the process if the “favorite channel display mode” is set off on the setting screen, as shown in FIG. 4, or captures items of information set for the favorite channel display mode (step S23). The channel history control section extracts program title information corresponding to the set favorite channels from items of electronic program information captured from broadcast signals or suchlike on ground wave digital broadcasting by the electronic program information processing section 36 (step 24).

Subsequently, in order to display the program titles corresponding to the favorite channels specified by the set items of information, the channel history control section causes the OSD superimposing unit 34 to create items of image information that include items of channel information and program title information corresponding to the channel information. Then, these items of image information are superimposed on video signals transmitted from the MPEG decoder 16, and a list of the results appears on the display unit 22, as shown in FIG. 8 (step S25).

Upon selection of one of the items of channel information with a cursor or suchlike (step S26), the channel history control section switches the BS/CS/ground wave digital tuner 12 to the channel thus selected (step 27). Accordingly, even in broadcasting that takes time to display on a screen, such as ground wave digital broadcasting, this enables a user to easily select a channel he or she likes by referring to his or her favorite program titles and the corresponding channels listed on the screen.

(Channel History Bundle Display Process: FIG. 6)

The channel history bundle display process performed by the broadcast receiving apparatus according to the present embodiment of the invention will now be described with reference to a flowchart in FIG. 6. The channel history bundle display process is the process of displaying a bundle of combinations of channels selected by a user in the past and program titles corresponding to the channels. FIG. 9 is a view illustrating the history channel bundle display process performed by the broadcast receiving apparatus.

Even in broadcasting such as ground wave digital broadcasting that takes time to display on a screen, this process enables a user to easily select a channel he or she likes by checking images on several channels and thereafter referring to a displayed bundle of images each of which shows a combination of the corresponding channel and program title.

The channel history display process proceeds as shown in a flowchart in FIG. 6. First, the channel history control section of the control unit 30 determines whether the channel history bundle display mode has been set or not (step S31).

In this case, the channel history control section shows the display, as shown in FIG. 7, provided for settings to be entered with the remote controller R or operating unit 32 by a user. Specifically, on the display as shown in FIG. 7, a user can set “a channel history bundle display mode.” The “channel history bundle display mode” can be set on or off, and the number of channel histories to be displayed can be set like “N=4.”

As in the case of the “channel history display mode,” character information for displaying EPG information is best set by entering the number of characters, such as “M=10 characters or less,” with the remote controller R or suchlike or by selecting the display entry “title information only” or “entire EPG information,” (not shown).

Additionally, as in the case of the “channel history display mode,” a “channel history specifying method” for one from a history of channels on the display may be specified with “cursor+selection button” or entering the number of seconds as in “after three seconds from cursor movement” with the remote controller R or suchlike, (not shown).

Further, as in the case of the “channel history display mode,” a “channel display character size” can be set by entering a character size such as “Q=10” with the remote controller R or suchlike.

The channel history control section of the control unit 30 ends the process if the “channel history bundle display mode” is set at off on such a setting screen as shown in FIG. 4. If it has been set at on, the control section determines whether a display key for the channel history bundle display mode has been depressed with the remote controller R or operating part 32 or suchlike (step 332).

When determining the depression of a key for displaying the channel history bundle display mode, the channel history control section captures items of information set for the channel history bundle display mode (step S33). Subsequently, the channel history control section collects from the storage unit 35 items of channel history information selected with the remote controller R or suchlike by a user (step S34).

Subsequently, if a tuner is selected for each from a history of channels, the channel history control section pre-stores images corresponding to the channels in the storage unit 35 (step S35). Then, the channel history control section reads each separate image from the storage unit 35, combines these images into a single image, and supplies this to the OSD superimposing unit 34, thereby causing the single image, as shown in FIG. 9, to appear on the display unit 22 (step S36).

Upon the selection of one of the channel histories with a cursor or suchlike (step S37), the channel history control section switches the BS/CS/ground wave digital tuner 12 to the channel thus selected (step 38). Accordingly, even in broadcasting such as ground wave digital broadcasting that takes time to display on a screen, a user may easily select a channel he or she likes by checking images on several channels and thereafter referring to a displayed bundle of images each of which shows a combination of the corresponding channel and program title.

While the invention has been described in its preferred embodiment, it is to be understood that ideas for further modifications may occur to those skilled in the art without departing from the spirit of the invention and, therefore, the invention is not limited to the embodiment described above.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A broadcast receiving apparatus comprising:
a tuner which selects one from a plurality of channels, demodulates a selected broadcast signal, and outputs a demodulation signal;
an extracting unit which extracts an electronic program information from the demodulation signal output from the tuner;
a superimposing unit which produces a video signal based on given channel history information and program title information corresponding to the channel history information, and superimposes the video signal onto a video signal produced based on the demodulation signal; and
a control unit which stores the channel history information selected by the tuner, extracts the program title information corresponding to the channel history information from the electronic program information of the extracting unit, and supplies the program title information to the superimposing unit together with the channel history information.

2. A broadcast receiving apparatus according to claim 1, further comprising:
a display unit which displays an image based on the modulation signal and an image based on the channel history information and program title information, wherein both the images have been superimposed by the superimposing unit.

3. A broadcast receiving apparatus according to claim 1, wherein, when there is an operation signal specifying one of the channels corresponding to the channel history information, the control unit causes the tuner to select the specified channel.

4. A broadcast receiving apparatus according to claim 3, wherein when a predetermined time elapses after the movement of a cursor on the superimposed images corresponding to the plurality of channels, the control unit determines that the channel specified by the cursor has been selected.

5. A broadcast receiving apparatus according to claim 1, wherein the channel history information is a history of channels the number of which has been set in advance.

6. A broadcast receiving apparatus according to claim 1, wherein the control unit sets the plurality of channels in advance, extracts the title information corresponding to the set channels from the electronic program information of the extracting unit, and supplies the program title information to the superimposing unit.

7. A broadcast receiving apparatus according to claim 1, wherein the control unit stores channel history information selected by the tuner and image information corresponding to each channel, extracts the program title information corresponding to the channel history information from the electronic program information of the extracting unit, combines images corresponding to the channels into a single image, and supplies the program title information and the corresponding channel history information to the superimposing unit.

8. A broadcast receiving apparatus according to claim 1, wherein the control unit stores channel history information selected by the tuner, extracts the program title information corresponding to the channel history Information within the predetermined number of characters and other information from the electronic program information of the extracting unit, and supplies the program title information and the other information to the superimposing unit together with the channel history information.

9. A broadcast receiving apparatus according to claim 1, wherein the control unit produces an image corresponding to the channel history information and program title information with a character size set in advance.

10. A broadcast reception method comprising:
selecting one channel from a plurality of channels by using a tuner;
demodulating a broadcast signal corresponding to the selected channel and outputting a demodulation signal;
extracting an electronic program information from the demodulation signal;
storing channel history information selected by the tuner, and extracting program title information corresponding to the channel history information from the electronic program information; and
producing a video signal based on the channel history information and program title information, superimposing the video signal onto a video signal produced based on the demodulation signal, and outputting the video signals superimposed.
